(19) United States
(12) Patent Application Publication
(10) Pub. No.: US 2014/0091087 A1
(43) Pub. Date: Apr. 3, 2014

(54) PORTABLE CUPCAKE DISPLAY AND PACKAGE

(71) Applicants: Carol B. Vollano, Branford, CT (US); Brenda D. DePonte, Branford, CT (US)

(72) Inventors: Carol B. Vollano, Branford, CT (US); Brenda D. DePonte, Branford, CT (US)

(21) Appl. No.: 14/036,897

(22) Filed: Sep. 25, 2013

Related U.S. Application Data
(60) Provisional application No. 61/705,695, filed on Sep. 26, 2012.

(51) Int. Cl. A47J 47/14; B65D 5/42; B65D 5/468; B65D 21/02; B65D 25/28

(52) U.S. Cl. CPC A47J 47/14; B65D 21/0209; B65D 25/2802; B65D 5/4608; B65D 5/4204
USPC 220/4.27; 206/562; 220/752; 229/117.14; 229/162.1

(57) ABSTRACT

A portable display tower and packaging for carrying and displaying cupcakes comprising a first level platform with a plurality of circular cavities for holding the cupcakes in place; a second level platform with a plurality of circular cavities for holding the cupcakes in place, wherein said second level platform is a different size than said first level platform; a means for connecting said base, said first level platform and said second level platform together in a perpendicular direction, spaced at a distance apart so that a user can easily view and remove the desired cupcake.

This application claims the benefit of U.S. provisional application No. 61/705,695 filed Sep. 26, 2012 which is incorporated herein in its entirety by reference.

### FIELD OF THE INVENTION

The present invention relates to a portable cupcake display tower. More particularly, the invention display tower is enclosed in a unique package for safe and easy transport of the baked goods.

### BACKGROUND OF THE INVENTION

When customers purchase cup cakes they don't always know how to display them to their guests. In general, when customers purchase cupcakes they are packaged in standard cupcake boxes—wherein the cupcakes are placed, unsecured, closely next to each other in a flat, horizontal manner—and are transported in their car or vehicle to their destination.

In addition, if the customer desires to display the cupcakes at a party or other function, they typically have to either rent or purchase a cupcake tower or display that is made of a non-disposable material such as wood, plastic or metal. Purchase prices of the display towers are costly and range from $65 to upwards of $400 each. Rental fees can range from $25-$50 depending on the size and style of the tower rented. Thus, renting or purchasing these display towers can be expensive, and if the towers are rented they must be returned within a specified short period of time.

Once the customer has the display tower at the desired location, the cupcakes have to be removed from the boxes and arranged on the tower or display. Because of the delicate nature of some of the cupcake toppings, customers fear that they will drop the cupcakes, smash them, or arrange them incorrectly or just not know how to perform this task on their own.

In general, cupcake carriers and holders are known in the prior art. See representative U.S. Pat. Nos. 7,614,518; 7,303,115; 5,912,033; 4,694,961; Des 659,483; Des 658,012; Des 515,363; Des 365,502 and U.S. Patent Publication Nos. 2010/00595580 A1 and 2007/0254075 A1.

In particular, DES 422,456 to Krueger discloses a 2-tier cup cake holder with a cover; DES 348,378 to Crane discloses a 3-tier cup cake holder with transparent cover and handle; U.S. Patent Publication 2010/02000583 to Curtain et al. discloses a stackable baked goods carrier with collapsible cover; and U.S. Patent Publication 2007/0007291 to Gunn discloses a container for carrying cupcakes and other pastry items including a series of plastic trays with a plastic dome cover.

Other cupcake carriers are found on the internet at www.allthingscupcake.com which discloses a cupcake display tower within a plastic container; www.2.bp.blogspot.com discloses a stackable baked goods carrier similar to U.S. Patent Publication 2010/0200583 A1; www.cupcaketowerstore.com discloses cupcake towers but no packaging; www.ehow.com discloses how to cover cupcake tower boxes as a temporary solution; and www.acupcakery discloses various cupcake boxes for one and two cupcakes, respectively.

As shown in the prior art, there is a need to provide the customer with a fully finished ‘no-assembly required’ cupcake tower, complete with cupcakes and decoration and a safe and sturdy way to transport the product out of the bakery and to the desired location destination.

The invention overcomes the problems of the prior art by providing a portable display tower for the cupcakes enclosed within a package for easy and safe transport. The assembled device is preferably made of cardboard and is rigid and sturdy. The display tower includes circular wells for placing and securing the cupcakes and is easily removed from the package without damaging the cupcakes. The display and packaging are disposable, but can also be re-used for additional occasions.

An advantage of the invention is for easy display and transport without causing damage to the baked goods.

Another benefit of the invention is to eliminate the need for the customer to arrange baked goods on a display.

Yet another benefit of the invention is to provide a unique package to transport baked goods.

### SUMMARY OF THE INVENTION

In the present invention, these purposes, as well as others which will be apparent, are achieved generally by a portable display tower for carrying and displaying cupcakes comprising a base; a first level platform with a plurality of circular cavities for holding the cupcakes in place; a second level platform with a plurality of circular cavities for holding the cupcakes in place, wherein the second level platform is a different size than said first level platform; a means for connecting the base, the first level platform and the second level platform together in a perpendicular direction, spaced at a distance apart so that a user can easily remove the desired cupcake.

The portable display tower is preferably arranged with the first level platform directly above the base and the second level platform directly above the first level platform.

In preferred embodiments, the first level platform and the second level platform are circular in shape and have different diameters. In alternate embodiments, the platform levels can be square, rectangular or oval in shape.

The first level platform preferably includes a plurality of cavities for holding up to 13 cupcakes.

The second level platform preferably includes a plurality of cavities for holding up to 8 cupcakes.

In an alternate preferred embodiment the invention includes a third level platform above the second level platform and has a plurality of cavities for holding up to 5 cupcakes.

While each platform level indicates a capacity for a certain number of cupcakes, it is within the scope of the invention to vary the number of cavities within these levels. Therefore each level may hold less or more than indicated.

The base, the first level platform, second level platform and third level platform are made of cardboard or corrugated paperboard and are disposable.

The means for connecting the base and the multiple level platforms is a cardboard insert. The invention tower is easily assembled by connecting and interlocking the respective cardboard pieces.

Also included in the invention is a unique cardboard package to enclose the display tower for safe and easy transport. The package includes at least one transparent display window.

Other objects, features and advantages of the present invention will be apparent when the detailed description of the preferred embodiments of the invention are considered with reference to the drawings, which should be construed in an illustrative and not limiting sense.

### BRIEF DESCRIPTION OF THE DRAWINGS

FIG. 1 illustrates the assembled components of the invention display;

FIG. 2 illustrates a frontal view of the a platform level according to the invention showing the plurality of cavities for holding cupcakes in place;

FIG. 3 illustrates a frontal view of another platform level according to the invention showing the plurality of cavities for holding cupcakes in place;

FIG. 4 illustrates a frontal view of another platform level according to the invention showing the plurality of cavities for holding cupcakes in place;

FIGS. 5A and 5B illustrate views of the two side panels of the packaging according to the invention;

FIG. 6 illustrates an open view of the assembled display tower with cupcakes inside the invention packaging; the display tower handle is also shown; and

FIG. 7 illustrates a closed view of the invention packaging with the display tower and cupcakes inside.

### DETAILED DESCRIPTION OF THE INVENTION

In accordance with the present invention a multi-level cupcake tower with a plurality of cavities on each level where the cupcakes fit into and are held securely in place, is provided.

The display tower of the invention provides the customer with an assortment of cupcakes displayed in a safe and secure manner on a cupcake tower/stand where they can easily be transported from one destination to another without further assembly. Each cupcake has its own individual hole on the tower that holds the cupcake in place. The cupcake tower comes packaged in a box that, when opened, reveals the entire cupcake tower and allows the customer to simply pick it up and place it down onto any table for consumption. There is no need for the customer/recipient to do anything further except to dig in and enjoy.

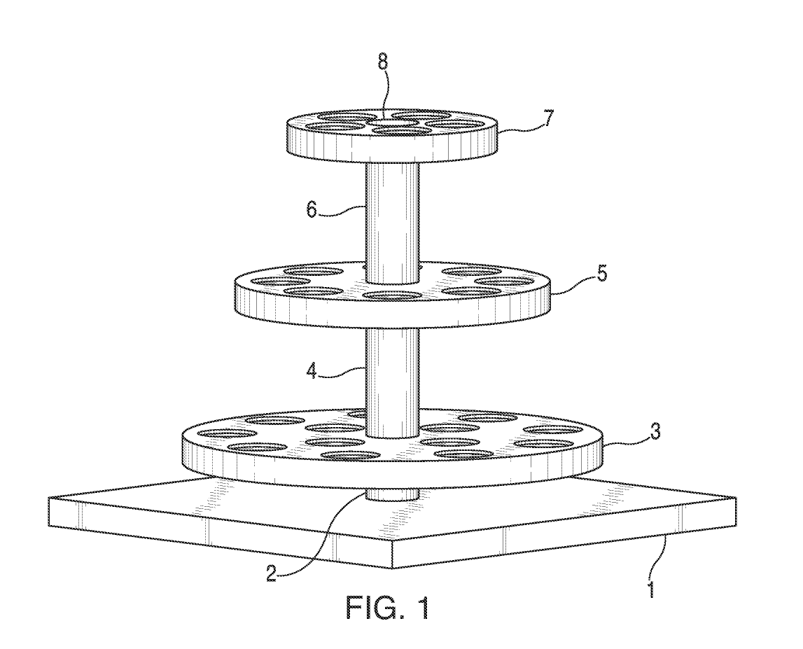

As shown in FIG. 1, the portable display tower of the invention for carrying and displaying cupcakes comprises a base 1; a first level platform 3 with a plurality of circular cavities for holding the cupcakes in place; a second level platform 5 with a plurality of circular cavities for holding the cupcakes in place, wherein the second level platform is a different size than said first level platform; a means for connecting the base, the first level platform 2 and the second level platform 4 together in a perpendicular direction, spaced at a distance apart so that a user can easily view and remove the desired cupcake.

The base 1 provides the tower with a degree of stability. In an alternate embodiment the first level platform may also serve as the base. In preferred embodiments where the base is present, the first level platform is a height above the base so that the cupcakes are readily accessible to the individual for viewing and consumption.

FIG. 1 also illustrates a third level platform above the second level platform and has a plurality of cavities for holding up to 5 cupcakes. This platform is smaller than the first and second level platforms.

Preferably, the base of the display is 18.5 inches long and 1.5 inches thick. The distance between the base and the first level platform is approximately 2 inches.

Preferably each level platform is 2.25 inches thick. The plurality of circular cavities in each platform level, are only deep enough to hold the cupcake in place. The depth of each individual hole is approximately ¼ inch deep, which is enough to hold the cupcake securely in place when the tower is transported. The platform level is required since it is needed to support the weight of the cupcake.

The portable display tower is preferably arranged with the first level platform directly above the base and the second level platform directly above the first level platform and preferably separated by a distance of at least 4 inches.

In preferred embodiments, the first level platform and the second level platform are circular in shape and have different diameters. In alternate embodiments, the platform levels can be square, oval or rectangular in shape. In other alternate embodiments, the first and second level platforms can be the same size.

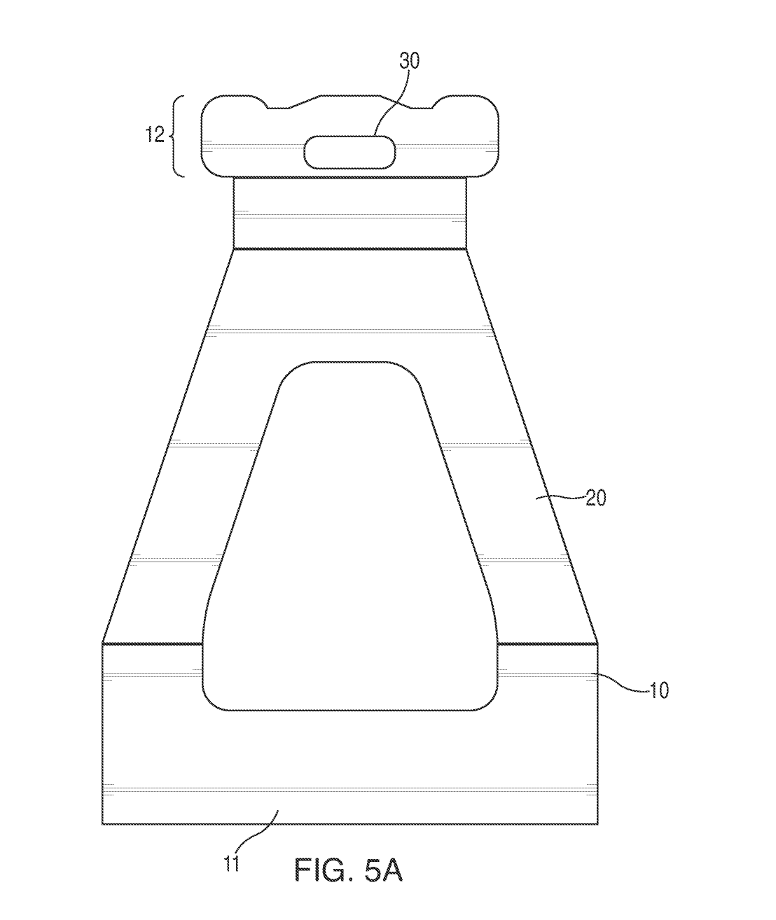

As shown in FIG. 4, the first level platform preferably includes a plurality of cavities 9 for holding up to 13 cupcakes. Center portion 4 for connecting the components is shown.

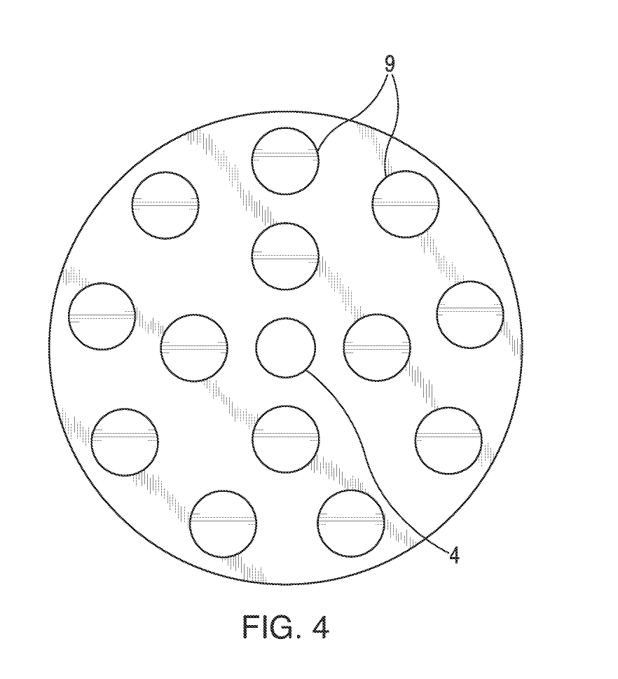

As shown in FIG. 3, the second level platform preferably includes a plurality of cavities for holding up to 8 cupcakes. Center portion 6 for connecting the components is shown.

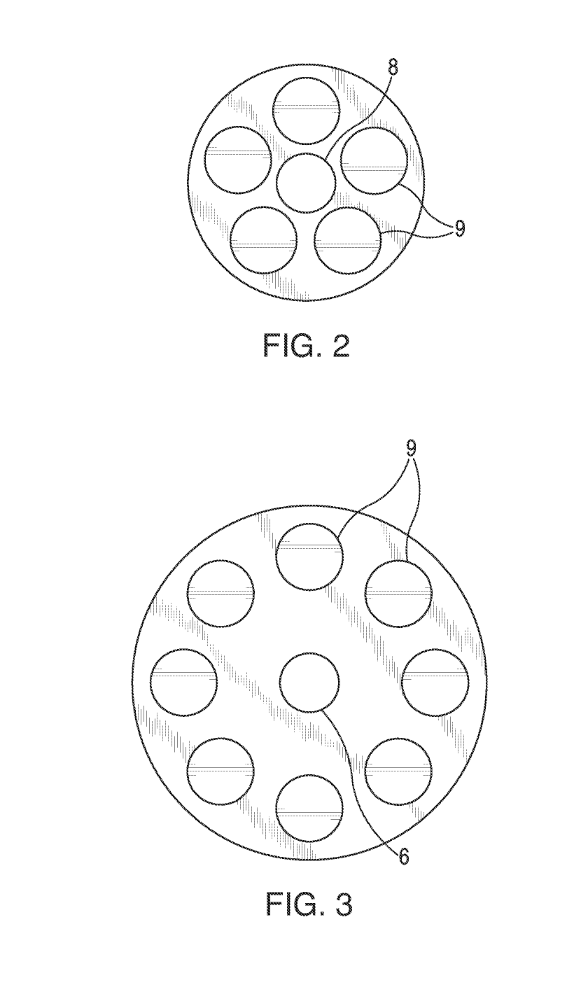

As shown in FIG. 2, the third level platform preferably includes a plurality of cavities for holding up to 5 cupcakes. Center portion 8 for connecting the components is shown.

While each platform level indicates a capacity for a certain number of cupcakes, it is within the scope of the invention to vary the number of cavities within these levels. Therefore each level may hold less or more than indicated.

The base, the first level platform, second level platform and third level platform are made of cardboard or corrugated paperboard and are disposable. Other materials may be used to construct the tower, including foam board and or synthetic materials that are light weight and disposable.

The means for connecting the base and the multiple level platforms is a cardboard insert. The invention tower is easily assembled by connecting and interlocking the respective cardboard pieces. The connecting insert can be a round, tubular shape that is in the center of the display. The insert can also be two pieces of cardboard or foam board that intersect at right angles to each other in the center of the display.

Also included in the invention is a unique cardboard package to enclose the display tower for safe and easy transport. The package includes at least one transparent display window.

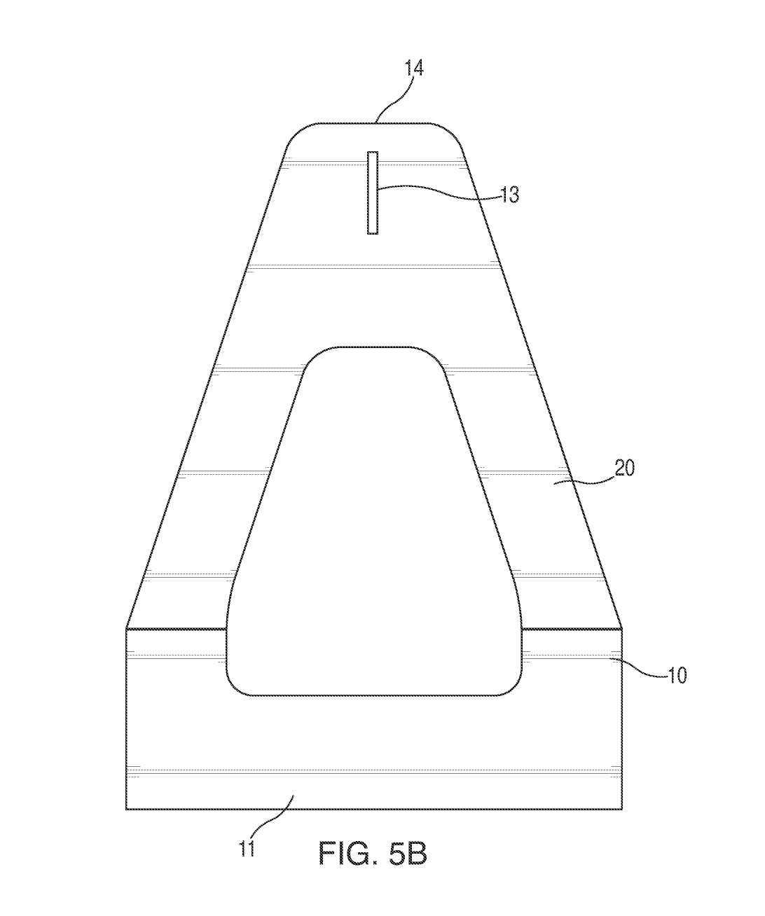

The tower is packaged inside a box which enables the user to transport the tower without damaging the baked goods inside. FIGS. 5A and 5B are illustrations of the two types of side panels used in the invention packaging. Both sets of side panel embodiments include a horizontal bottom portion 11 attached to a base panel. The same side panel is arranged opposite each other on the base portion.

Two perpendicular portions 10 extend from the bottom portion. Two slanted portions 20 extend inward from said perpendicular portions. In FIG. 5A, the first set of side panels, include a top portion 12 illustrates an inverse triangular top flap. This top portion may also include an opening 30 which serves as a handle to carry the package. In FIG. 5B, the second set of side panels, there is no top portion 12 as in FIG. 5A, instead the slanted portions 20 connect at top edge 14. There also is a slit 13.

The package is constructed so that the inverse top flaps 12 of FIG. 5A are on opposite sides and fold together. The remaining sides, illustrated in 5B fold up interlock thru the top slit 13 on the side panel for closure. When ‘unlocked’, the flaps are easily released and fold down to allow for easy access and removal of the cupcake tower. To remove the fully assembled cupcake tower, the individual simply slips two fingers into the finger holes cutouts located at the top of the tower, pick-up and place on a table.

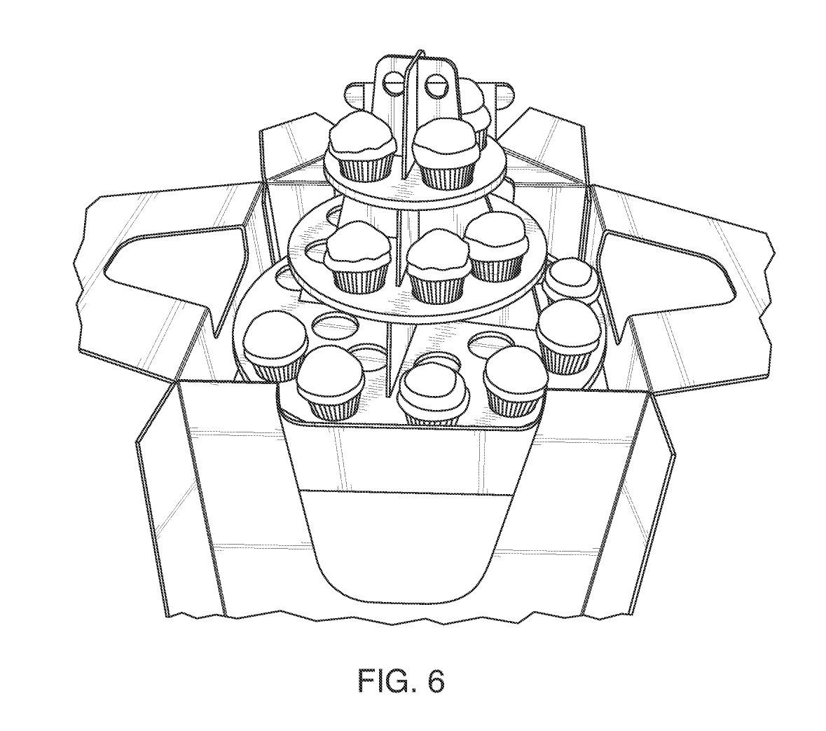

FIG. 6 illustrates an open view of the package according to the invention and shows the handle of the display tower. The handle in this embodiment is shown as two hole cutouts at the top of the tower. The individual's fingers fit into these cutouts for secure transport of the tower.

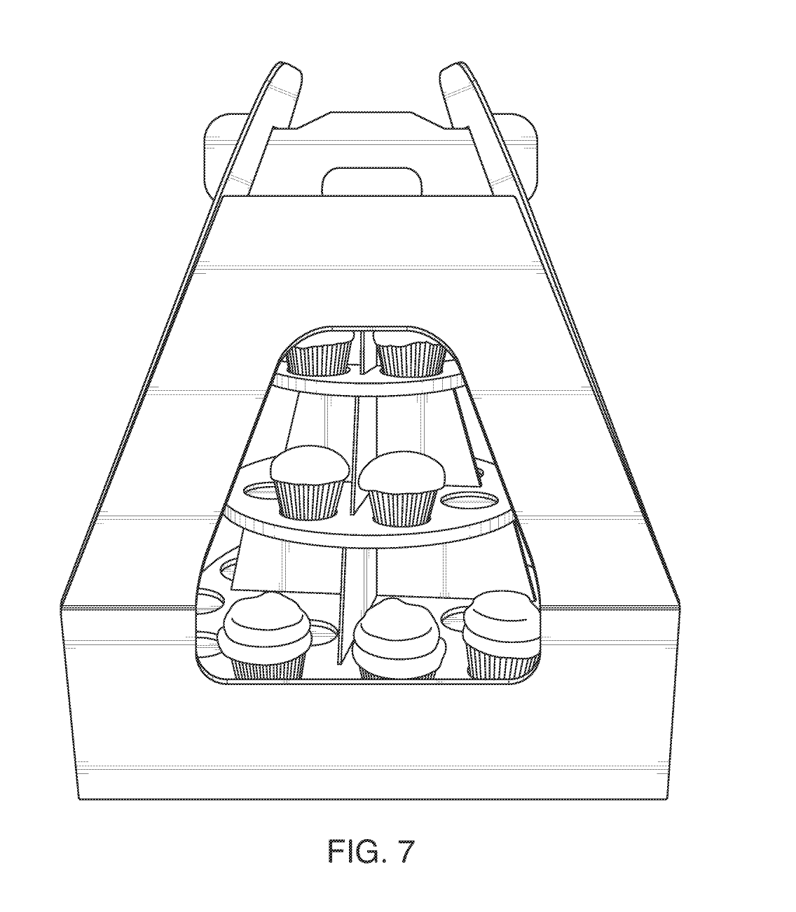

FIG. 7 is an illustration of a closed view of the package according to the invention where each of the four side panels have been folded up and the inverse top flap portions are interlocked.

While certain embodiments have been described the invention includes other platform level sizes. In all embodiments, the same structural elements are utilized and they will simply be different sizes and hold more or fewer cupcakes.

The foregoing description of various and preferred embodiments of the present invention has been provided for purposes of illustration only, and it is understood that numerous modifications, variations and alterations may be made without departing from the scope and spirit of the invention as set forth in the following claims.

What is claimed is:

1. A portable display tower for carrying and displaying cupcakes comprising:
a first level platform with a plurality of circular cavities for holding the cupcakes in place;
a second level platform with a plurality of circular cavities for holding the cupcakes in place, wherein said second level platform is a different size than said first level platform;
a means for connecting said base, said first level platform and said second level platform together in a perpendicular direction, spaced at a distance apart so that a user can easily view and remove the desired cupcake.

2. The portable display tower according to claim 1, further comprising a base, wherein said first level platform is directly above said base.

3. The portable display tower according to claim 1, wherein said second level platform is directly above said first level platform.

4. The portable display tower according to claim 1, wherein said first level platform and said second level platform are circular in shape and have different diameters.

5. The portable display tower according to claim 1, wherein said first level platform includes a plurality of cavities for holding up to 13 cupcakes

6. The portable display tower according to claim 1, wherein said second level platform includes a plurality of cavities for holding up to 8 cupcakes

7. The portable display tower according to claim 1, further comprising a third level platform above said second level platform and includes a plurality of cavities for holding up to 5 cupcakes.

8. The portable display tower according to claim 1, wherein said base, said first level platform and said second level platform are made of cardboard, corrugated paperboard, foam board or similar material.

9. The portable display tower according to claim 1, wherein the means for connecting said base, said first level platform and said second level platform is a cardboard, paperboard or foam board insert in the center of said base and said first and second level platform.

10. The portable display tower according to claim 9, wherein said insert is two pieces of cardboard, paperboard or foam board intersecting at right angles to each other.

11. The portable display tower according to claim 9, wherein said insert is a round, tubular shape.

12. The portable display tower according to claim 1, further comprising a handle for carrying the portable display tower.

13. The portable display tower according to claim 1, further comprising a cardboard package enclosing the display tower with at least one transparent display window.

14. A package for transporting baked goods comprising:
a flat base panel; and
two sets of side panels, said first set including a horizontal bottom portion 11 attached to said base panel opposite each other each having two perpendicular portions 10 extending from the bottom portion and two slanted portions 20 extending inward from said perpendicular portions with a top portion 12 comprising a top flap; and said second set including a horizontal bottom portion 11 attached to said base panel opposite each other each having two perpendicular portions 10 extending from the bottom portion and two slanted portions 20 extending inward from said perpendicular portions connecting at top edge 14 and including a slit 13.

15. The package according to claim 14, wherein said first set of side panels include a top portion having an opening 30 used to carry the package.

16. The package according to claim 14, wherein said top flaps 12 of said first set are on opposite sides and fold together and said second set fold together such that the top flaps 12 interlock thru the top slit 13 for closure.
